(19) United States
(12) Patent Application Publication
(10) Pub. No.: US 2019/0381658 A1
(43) Pub. Date: Dec. 19, 2019

(54) METHOD FOR CONTROLLING A ROBOT

(71) Applicant: Siemens Healthcare GmbH, Erlangen (DE)

(72) Inventors: Holger Mönnich, Friedberg (DE); Rafik Mebarki, Furth (DE)

(21) Appl. No.: 16/437,162

(22) Filed: Jun. 11, 2019

(30) Foreign Application Priority Data
Jun. 13, 2018 (EP) 18177540.4

(51) Int. Cl. B25J 9/16; B25J 17/02

(52) U.S. Cl. CPC B25J 9/1664; B25J 17/0283

(57) ABSTRACT

A system and method are provided for controlling a robot for automatic positioning of a tool in a predetermined target pose. A six dimensional pose of a robot flange corresponding to the target pose is determined. An expanded kinematics of the robot is created by augmenting it with a virtual joint arranged in the tool. The virtual joint makes possible a restriction-free virtual rotation about a predetermined axis of the tool. From the six dimensional pose of the robot flange and the expanded kinematics, a path is determined by an automatic path planning module, in accordance with which the six dimensional pose of the robot flange may be moved to from an initial pose of the robot. Conflicts with a maximum physical scope of movement of the robot occurring during this process are resolved by a rotation of the virtual joint.

### CROSS REFERENCE TO RELATED APPLICATIONS

This application claims the benefit of EP1817754.4, filed on Jun. 13, 2018, which is hereby incorporated by reference in its entirety

### FIELD

Embodiments relate to a method for controlling a robot and to a corresponding robot.

### BACKGROUND

Robots with movable robot arms are being used ever more widely nowadays in many areas of technology and industry. The robots may position components or tools at a predetermined position and in a predetermined orientation or alignment, i.e. in a predetermined pose, in space. In general, this is a six dimensional problem, i.e. a problem with or in 6 dimensions or degrees of freedom. These are three-point coordinates or space coordinates for the position and three angles for the orientation. However, if the tool to be positioned is rotationally symmetrical about, i.e. in relation to, an axis of symmetry and/or if a rotation or rotary position of the tool about a specific axis is insignificant or irrelevant for an application or function of the tool, then the problem involved is effectively a 5D problem. A conventional approach includes specifying a fixed rotation about the specified axis determined, so that a six dimensional pose for the tool is produced as the target position to be moved to. With a conventional method a corresponding control sequence for the robot is then determined for this six dimensional pose. With this method the robot cannot assume or set the predetermined six dimensional pose for the tool, for example because of mechanical limitations. Moreover, other possible solutions, i.e. corresponding control sequences, that might possibly lead to an improved performance or efficiency, are automatically excluded or discarded.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments improve a robot control for a positioning of a tool.

An embodiment provides for controlling a robot for automatic positioning of a tool, for example, a tool functionally rotationally symmetrical about a predetermined axis, in a target pose. The robot includes a movable robot arm, that includes a robot flange on an end side, i.e. on a distal end. The tool for is held on the robot flange. The tool may either be held directly, i.e. right against, or indirectly, i.e. at a distance from the robot flange. In other words, the tool itself may thus be fastened to the robot flange. However, a tool holder or a connecting element may also be fastened directly to the robot flange and the tool may be fastened to this tool holder or connecting element. The indirect arrangement provides that the tool is held on the robot flange. The term “tool” is to be interpreted very broadly and may in principle includes any objects held or guided by or on the robot or robot flange respectively, i.e. for example also a workpiece or semi-finished item or the like. The tool may thus just as well be a component or device or the like.

As a part of the method, 3D point coordinates or 3D-space coordinates of a reference point of the tool, an axis of the tool and an orientation of the axis are predetermined as part of the target pose for the tool. The orientation may be predetermined in the form of two angles or in the form of two directions or direction vectors, that may be at right angles to the predetermined axis and to one another. The target pose for the tool is thus predetermined as a 5D pose. An angular setting of the tool in relation to a rotation about the predetermined axis does not initially have to be specified. Subsequently a corresponding six dimensional pose for the robot flange is determined for the predetermined target pose for the tool by known methods known. The six dimensional pose of the robot flange is automatically determined so that the tool held on the robot flange is located in the target pose predetermined for the tool, when the robot flange is located in the corresponding six dimensional pose determined for this. A spatial positional relationship between the tool and the robot flange or between the robot flange on one side and the reference point as well as the predetermined axis of the tool on the other side may be determined, i.e. known, for example, be fixed or constant.

The predetermined axis of the tool may be an axis of symmetry of the tool. The term “axis of symmetry” may be understood and used in the sense both geometrically and functionally. The method may thus be applied for positioning of a tool, that is rotationally symmetrical and/or of which the function, application or use does not depend on the rotation or rotational position in relation to at least one, e.g. at least the predetermined axis for the positioning, i.e. is not influenced or not adversely affected if the tool might thus be rotated in the target pose in any given way about the predetermined axis. The corresponding axis may thus be an axis of symmetry in a geometrical and/or in a functional respect. The term “axis of symmetry” used below is thus not to be understood purely geometrically. Likewise, for example a discrete symmetry in respect of rotations about the axis is produced, so that thus only rotations by specific discrete angular amounts lead to a geometrical correspondence of the respective positions of the tool. Likewise, it may be possible for the tool to be held so that the tool may be rotated or turned about the corresponding axis by the robot, for example, on the robot flange. The tool may then be moved manually into a desired rotational or turned position by a user or an operator for example after the tool has been positioned in the predetermined target pose. The method may thus ultimately be employed for positioning any given tools or objects.

In a further step a predetermined kinematics of the robot is expanded, i.e. augmented by supplementing the robot with a virtual joint arranged or positioned in the tool. The predetermined kinematics of the robot might be a kinematic model of the robot, that defines or describes a relative position or an interaction of real joints and connecting elements between these joints. The kinematics or the kinematic model of the robot is then added to the virtual joint virtually, i.e. computationally, by corresponding data processing. The virtual joint is a rotary or swivel joint, that makes possible a restriction-free rotation in the or about the predetermined axis or axis of symmetry of the tool. Since only a virtual, i.e. computationally predetermined or modeled, joint is involved, the joint or a rotation respectively, i.e. a maximum angle of rotation or scope of movement, is not subject to any physical limitations, such as may be the case for real joints of the robot. The expansion of the predetermined kinematics of the robot may likewise be carried out at another point of the method, i.e. for example before the method steps already described.

In a further method step, the six dimensional pose of the robot flange determined and the expanded kinematics is provided to an automatic path planning module, also referred to as an automatic path planner. A path is determined automatically by the automatic path planning module, in accordance with which the six dimensional pose of the robot flange determined from a respective current pose of the robot may be moved to or set. Conflicts occurring in such cases with a maximum physical scope of movement of the robot are resolved automatically by the automatic path planning module by at least one rotation of the virtual joint. In other words, it is thus left to the path planning module to find or to determine a suitable rotation or angular position for the virtual joint in order to position the tool in the predetermined target pose. The respective current initial position of the robot may for example be determined automatically by a robot controller, for example by reading out current joint settings or joint variables and/or with reference to a predetermined model of the robot.

The types of automatic path planning modules may be known and are already employed numerous times nowadays for known robot controllers. The path planning module in such cases initially insures that a corresponding portion of the path defined for the real robot or for the real joints of the robot is collision and conflict-free, i.e. taking into consideration real or physical limitations and limits of the robot itself and/or if necessary of the robot's surroundings that may move to by the robot, i.e. set or reached. Since the additional virtual joint is not subject to any physical restrictions, an ultimately purely virtual or computational rotation of the virtual joint about the predetermined axis of the tool provides the predetermined target pose to be set or reached. This is also the case when the real robot cannot carry out or complete the virtual rotation about the predetermined axis—because of mechanical restrictions for example. Since however the target pose for the tool is ultimately a 5D pose because of the tools at least functional and if necessary geometrical rotational symmetry, this may be set or maintained regardless of the rotation of the virtual joint. In other words the method thus uses the state of the functional and if necessary geometrical rotational symmetry of the tool, in order to make it possible, by being able to set any given angle of rotation of the virtual joint as dictated by the situation or requirement, to reach the target pose for the tool ultimately restricted in five dimensions or degrees of freedom or to make possible the ability to reach said pose. Embodiments provide in a more flexible and reliable manner than conventional methods, to find a practicable path, i.e. one that may be carried out in practical terms. For the robot for positioning of the tool in the predetermined target pose. The specific path is not subject to the restrictions of the conventionally used methods. In a greater number of situations or cases this provides a solution to be found for the respective positioning problem, that takes account of the mechanical limitations of the robot. Moreover, where necessary a solution that may be implemented practically with optimized performance is found.

The method may be employed for a wide diversity of types of robot and in the most diverse technical or industrial areas of application, i.e. to good effect. The robot may thus be an industrial robot, a lightweight robot, a medical robot or the like. Such robots may include at least six degrees of freedom, i.e. corresponding joints or axes. Accordingly, the tool, as described, may ultimately be almost any given object. An application lies in the positioning of a guide sheath for needle or an injector or the like (NGS, “needle-guide sheath”). Such a guide sheath provides a needle or an injector or the like to be guided—for example as part of an interventional treatment of a patient. A precise positioning of the guide sheath, i.e. of the tool, provides a predetermined target point in or on the patient to be reached precisely and reliably by the needle or the injector in or from a predetermined direction. The guide sheath includes an inner or hollow space, along which the predetermined axis runs. Through the inner or hollow space, the needle or the injector is guided along the predetermined axis. From a functional point of view, it is irrelevant whether or how far the guide sheath is rotated about the predetermined axis when the needle or the injector is guided along the predetermined axis through the guide sheath in the direction of the patient or target object. The guide sheath is thus functionally rotationally symmetrical in relation to the axis. Depending on an embodiment of the guide sheath, this may also be geometrically rotationally symmetrical in relation to the axis. This may apply just as well for example only for the inner or hollow space. An application for a guide sheath may be a spinal column treatment or operation. In a corresponding way the symmetry properties described for the guide sheath may be transferred to or generalized for other tools.

The method itself may not include any surgical steps and the tool may be positioned outside the patient, i.e. not come into contact with the patient. The actual interaction with the patient may be by the needle or the injector, that are not part of the method. The method is concerned with the control, i.e. with the operation, of the robot. A direct surgical application may be excluded.

In an embodiment, the path determined is automatically transferred or provided to a control device of the robot. The robot is activated automatically by the control device in accordance with the path defined, so that the robot flange arrives at the pose determined for it and thus the tool gets into the predetermined target pose. In other words, after the predetermined target pose for the tool has been received, the robot is thus automatically controlled and moved or transferred into the target pose. To do this the expansion of the predetermined kinematics and the provision of the six dimensional pose determined and of the augmented kinematics to the automatic path planning module may be carried out in an automated manner. Corresponding data may be stored, for example, in a data memory linked to the control device and retrieved automatically from the memory by the control device. The data memory and/or the automatic path planning module may be part of the control device. The transfer of the path defined to the control device may lead to that the path defined will be passed on to a further module or a corresponding function or functional unit of the control device. The control device may be part of the robot or part of a larger robot system. The control device may be integrated into the robot itself or be arranged in a separate housing for example. The flexibility and reliability of the method for or when finding a mechanically permitted path for the robot for positioning of the tool in the predetermined target pose provides the method to be largely automated.

In an embodiment, current values of joint variables q of the real joints of the robot in the initial pose are automatically determined, a set of joint variables (q, qᵥ) is provided as part of the expanded kinematics and a set of target joint variables (q*, qᵥ*), that are present in the target pose, i.e. are to be reached, is determined by the automatic path planning module as part of the path. The lower index “v” refers to the virtual joint, while the upper index “*” refers to the target values of the respective joint variables corresponding to the predetermined target pose. The joint variables q, q_{v∈} [symbol] ⁿ may be used as coordinates in an abstract space, in which the joints are represented. The space is also referred to as the joint or configuration space. The dimension n of the configuration space corresponds to a number n of the independent joints and thus to a number of the degrees of freedom of the robot. The configuration space of the real robot may thus include the dimension n, while a virtual robot, that corresponds to the real robot expanded by the virtual joint, may include a configuration space of dimension n+1. The joint variables q, qᵥ may include or specify the respective settings, i.e. the angular and/or movement positions, of the respective joints. The use of the joint variables q, qᵥ provides for compatibility of the method with conventional robot controls.

In an embodiment, a center point of the tool is predetermined as the position of the virtual joint. The virtual joint is positioned in the center the tool or the center point of the tool is predetermined as the anchor point of the virtual joint. Although the virtual joint might be positioned at any given point of the tool, the positioning or arrangement of the virtual joint in or at the center point of the tool may however make possible an especially simple computation and a clear understandability of a corresponding model, a corresponding computation and/or a corresponding result. The arrangement of the virtual joint in the center point of the tool moreover provides the virtual rotation about the predetermined axis or axis of symmetry of the tool to be carried out or modeled reliably and consistently, since the predetermined axis of the tool also runs through the center point of the tool. The center point of the tool may be related in such cases to one or more, e.g. to all, directions or dimensions of the tool.

In an embodiment, a tip of the tool facing away from the robot flange is used as the reference point of the tool. The point in space at which the tip of the tool is to be located when the tool is positioned in the target pose is thus predetermined for the target pose or as part of the target pose for the tool. Although any given point of the tool may be predetermined as the reference point, the use of the tip of the tool is advantageous however, since an accidental or undesired contact between the tool and a target object, for example the patient or a workpiece to be processed, may be avoided by this in a reliable manner. If instead, for example, an end facing towards the robot flange or a point of the tool lying between these ends were to be predetermined as the reference point, a source of errors might include a respective user not taking account of this when specifying the 3D space coordinates of the reference point. The tip of the tool might be positioned closer to the target object than intended, e.g. by exactly a distance between the reference point and the tip of the tool. Using the tip of the tool as reference point in this way provides a simple and secure operability, i.e., use. The tip of the tool facing away from the robot flange is facing towards the respective target object in the predetermined target pose, thus may form a point of the tool lying closest to the target object.

In an embodiment, a virtual connecting element is predetermined in addition to the virtual joint, that connects the virtual joint to the reference point and/or to a tip of the tool facing away from the robot flange. The real robot is expanded virtually by an additional virtual element of the movable robot arm, providing rotations of the virtual joint to be carried out or processed especially reliably and consistently by known robot controls or kinematics models. Moreover, in the respective model of the robot the reference point or the tip of the tool may be positioned reliably and consistently even with a rotation of the virtual joint in accordance with the predetermined target pose. Thus, a source of errors may be avoided in a reliable manner, that a behavior of the reference is undefined for a rotation of the virtual joint in the respective model, since the reference point or the tip of the tool is only coupled to the virtual joint by the virtual connecting element. No additional outlay in components is necessary, since the virtual connecting element is predetermined, i.e. just virtually added-on purely computationally by corresponding data processing or modeling, so that no changes to the real robot are necessary.

In an alternate embodiment, the reference point of the tool is predetermined as the position of the virtual joint providing a simple and effortless computation of the path or an effortless modeling of the robot to be produced.

In an embodiment, an ancillary condition is passed to the automatic path planning module, that is complied with automatically by the automatic path planning module on determination of the path by at least one virtual rotation of the virtual joint, provided no conflict with a physical limitation of the robot arises. The ancillary condition may be or characterize a property of a pose of the robot arm when the tool reaches the target pose. The freedom or the uncertainty of the target pose for the tool in respect of the angular setting or rotation about the predetermined axis or axis of symmetry of the tool is utilized in order instead to predetermine the ancillary condition, i.e. a further or other boundary or mandatory condition. In this way it may be predetermined as an ancillary condition for example that a specific element of the movable robot arm may extend in a specific direction or a specific area of space should be kept free, i.e. not occupied by the robot arm. The types of additional prerequisites or conditions, with a complete, rigid definition of the target pose in six dimensions, may lead to the additional prerequisites or conditions not being able to be reached or set by the robot. However, the freedom from restrictions of the virtual joint may be utilized in order to comply with the ancillary condition providing cooperation between the robot and human personnel to be improved for example simplified and/or designed safely. A handling or positioning of the target object may be simplified, since for example a specific area of space may be kept free, whereby it may be made easier to access the target object.

An embodiment includes a data memory with program code, that encodes or represents the method steps of at least one form of embodiment of the method.

An embodiment includes is a robot with a movable robot arm, that on an end side includes a robot flange for holding a tool, for example, a tool functionally rotationally symmetrical about a predetermined axis. The robot further includes a control device, that includes an interface for receiving specifications, a data memory and a processor device connected to the memory and to the interface for executing the program code stored in the data memory. The robot is configured for executing or carrying out at least one form of embodiment of the method. Accordingly, the robot may have the properties and/or components or devices stated in connection with the method.

### BRIEF DESCRIPTION OF THE FIGURES

FIG. 1 depicts a schematic perspective view of a robot according to an embodiment.

FIG. 2 depicts an example of a schematic flowchart of a method for controlling the robot of FIG. 1 according to an embodiment.

### DETAILED DESCRIPTION

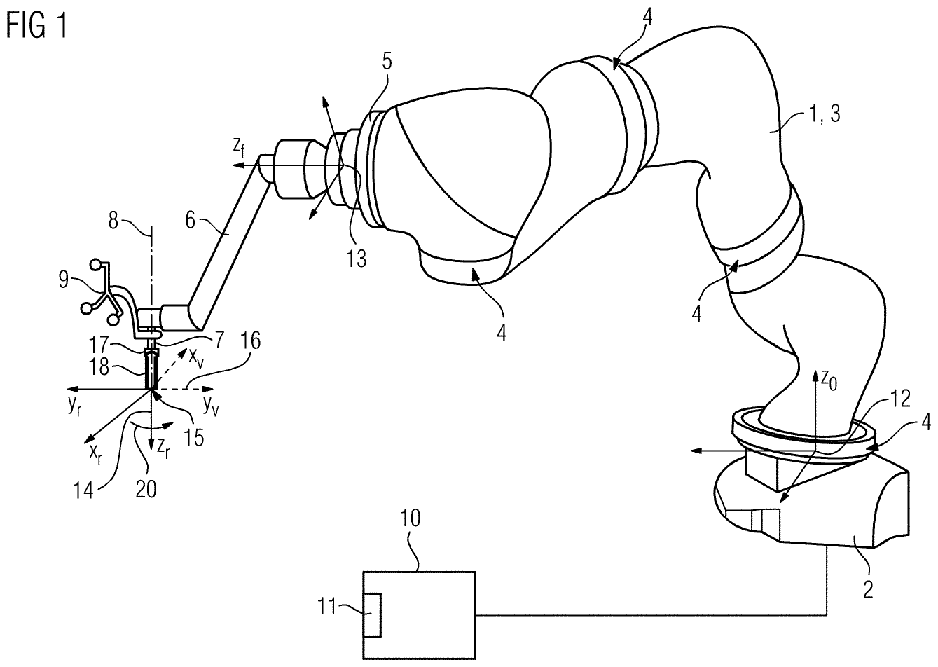

FIG. 1 depicts a schematic perspective view of a robot 1 with a robot foot 2 and a movable robot arm 3 connecting to said foot. The robot foot in this example is arranged at a fixed location in relation to the surrounding spatial coordinate system, i.e. in relation to a surrounding room in which the robot 1 is located. The movable robot arm 3 includes a number of joints 4, of which a few are labeled by way of example. Arranged on a distal end of the robot arm, i.e. at the end of the movable robot arm 3 lying opposite or facing away from the robot foot 2 is a robot flange 5. Attached to this robot flange 5 in the example depicted is a tool holder 6, on which or by which, a tool 7 is held. The tool 7 in the example shown here is a needle-guide sheath (NGS), that is also embodied at least functionally and depending on embodiment for example geometrically rotationally symmetrical about a predetermined axis indicated schematically here, that is thus accordingly designated here as the axis of symmetry 8. The axis of symmetry 8 extends in the longitudinal direction centrally through the tool 7 along the tool's main extent.

An optical marker 9 attached to the tool 7 is depicted. The marker 9 may be detected by a detection device, for example by a camera, in order to determine or to trace a current orientation of the marker 9 and thus of the tool 7 in each case from any perspective. Furthermore, a control device 10 connected to the robot 1 is depicted schematically. The control device 10 may be part of the robot 1. The control device 10 includes a user interface 11, via which user inputs or specifications may be received. The control device 10 includes a data processing unit not shown, that processes inputs or specifications received via the user interface 11 and may create a corresponding control signal for the robot 1 and may activate the robot 1 in accordance with the control signal.

For orientation or illustration a few Cartesian coordinate systems are depicted here, that may be taken into account or used in the control of the robot 1 or when determining or creating the control signal for the robot 1. In the present example the coordinate systems are a basic coordinate system 12, of which the origin is arranged on the robot foot 2. The basic coordinate system 12 is rotationally and positionally fixed relative to the robot foot 2. Depicted on the robot flange 5 is a flange coordinate system 13, that specifies a pose of the robot flange 5 or in which a pose of the robot flange 5 may be expressed without further coordinate transformations. Depicted at a tip of the tool 7 facing away from the robot flange 5 is a tool coordinate system 14. An origin of the tool coordinate system 14 coincides with the tip of the tool 7 and a z-axis zᵣ of the tool coordinate system 14 coincides with the axis of symmetry 8 of the tool 7. Through the or on the basis of the orientations of the x- and y-axes xᵣ or yᵣ of the tool coordinate system 14 a rotation or angular setting of the tool 7 about the axis of symmetry 8, i.e. about the z-axis zᵣ of the tool coordinate system 14, may be specified or described. Also indicated is a target pose 16 for the tool 7 by corresponding orientations of the x- and y, axes of the tool coordinate system 14, here designated as xᵥ or yᵥ respectively.

The ultimate aim is to control or move the robot 1 so that the tool 7 will be positioned in accordance with the target pose 16. To this end a pose for the robot flange 5 corresponding to the target pose 16 for the tool 7 is found. The robot 1 may be positioned automatically so that the tool 7 arrives at or is transferred to the target pose 16. When the target pose 16 is reached, a needle may be guided for example through the tool 7 along the axis of symmetry 8, to reach a specific target point from a specific direction. Although the rotation or angular setting of the tool 7 about the axis of symmetry 8 is ultimately of no significance, the corresponding pose of the robot flange 5 must however be determined completely, i.e. in six dimensions. Finding such a six dimensional pose for the robot flange 5 on the basis of a predetermined 5D pose for the tool 7 is however an open problem with potentially a plurality of possible solutions, that may be problematic in respect of computation speed for example.

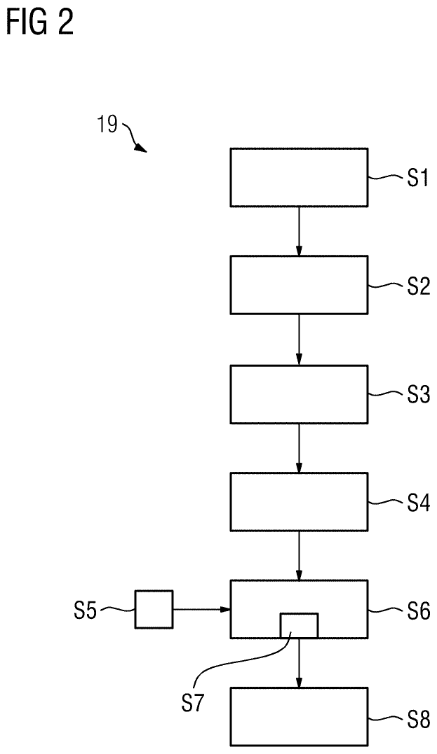

FIG. 2 shows an example of a schematic flowchart 19 of a method for control of the robot 1 for automatic positioning of the tool 7 in the target pose 16. The method utilizes that the tool 7 may be positioned in or with any given angular setting in respect of a rotation about the predetermined axis of symmetry 8 in the target pose 16 without adversely affecting an application, use or function of the tool 4.

The method begins in a method step S1. Here the robot 1 or the control device 10 may be activated. The coordinate systems 12, 13, 14 may be predetermined or defined. Furthermore, a kinematics model of the robot 1 may be provided. The control device 10 may determine a current pose, i.e. a respective initial pose, of the robot 10, for example by interrogating current joint settings or joint variables of the joints Q of the robot 1.

In a method step S2 the target pose 16 is predetermined, by 3D space coordinates of a reference point 15 of the tool 7—in the present case of the tip of the tool 7 facing away from the robot flange 5—and an orientation of the axis of symmetry 8, i.e. of the z-axis zr of the tool coordinate system 14, may be predetermined or defined.

In a method step S3 an expanded kinematics of the robot 1 is created, by a predetermined kinematics of the robot 1 being augmented by a virtual joint 17 and a virtual connecting element 18. The predetermined kinematics describes a behavior of the real joints 4 of the robot 1. The virtual joint 17 on the other hand does not exist on the real robot 1. The virtual joint 17 makes possible virtually, i.e. in a corresponding model, a restriction-free rotation about the axis of symmetry 8. The virtual connecting element 18 connects the virtual joint 17 to the reference point 15, i.e. to the tip of the tool 7.

In a method step S4 a six dimensional pose for the robot flange 5 corresponding to the predetermined target pose 16 is determined.

The predetermined target pose 16 and the corresponding six dimensional pose for the robot flange 5 are provided to an automatic path planning module of the control device 10.

In a method step S5 a predetermined ancillary condition for a pose of the robot 1, that the robot 1 assumes is predetermined for the automatic path planning module when it has positioned the tool 7 in the predetermined target pose 16.

In a method step S6, taking into account the ancillary condition, the expanded kinematics and the six dimensional pose for the robot flange, a path is determined by the automatic path planning module, in accordance with which the six dimensional pose of the robot flange 5 determined may be moved to or set from the initial pose of the robot 1. Let q=(q₁, q₂, . . . , qₙ)∈ [symbol] ⁿ be a vector, that specifies the joint variables of the real joint 4 of the robot 1. In the present example the robot 1 is to be a lightweight robot with seven joints 4, so that n=7 applies. Let q̅=(q, qᵥ)∈ [symbol] ⁿ⁺¹ further be a vector, that specifies or represents the joint coordinates of the expanded kinematics. The virtual joint 17 is thus introduced or expanded by qᵥ∈ [symbol] . By application methods known per se in the area of robot control, the automatic path planning module may generate a path (q*, qᵥ*)∈ [symbol] ⁿ⁺¹, through which the robot 1 is moved with expanded kinematics so that the z-axis zᵣ of the tool coordinate system 14, i.e. the axis of symmetry 8, and the position of the reference point 15 corresponds to the predetermined target pose 16. In accordance with the virtual, i.e. expanded kinematics, the virtual connecting element 18 may be rotated or will be rotated in any given manner, e.g. without limitations or physical restrictions, about the z-axis zᵣ. The automatic path planning module insures however that the portion q* of the path determined or generated for the real robot is able to be executed, i.e. does not lead to conflicts with physical limitations, for example a maximum scope of movement, of the real robot 1.

When the portion q* has been determined, as part of the determination of the path in a method step S7, a virtual rotation 20 of the virtual connecting element 18 about the virtual joint 17 or about the z-axis zᵣ respectively, indicated here by a corresponding arrow, is carried out, until an orientation of the x- and y-axes xᵣ, yᵣ of the tool coordinate system 14 corresponds to the orientations of the predetermined orientations xᵥ, yᵥ, so that the tool coordinate system 14 has thus reached the target pose 16. Through the concluding rotation 20 the predetermined target pose 16 is thus reached and even occurs if this could not be reached by the real robot 1, since for example an adjustment scope of the virtual rotation 20 cannot be realized through a limited maximum physical scope of movement of the robot 1. Through the virtual rotation 20 the predetermined target pose 16 may thus still be reached by utilizing the free adjustability of the virtual joint 17.

In a method step S8 a control signal corresponding to the path (q*, qᵥ*) determined is created by the control device 18 and output to the robot 1, so that the robot flange is moved into the six dimensional pose and thus the tool 7 is moved into the predetermined target pose 16. The virtual rotation 20 does not actually have to be carried out for real, since as a result of the at least functional rotational symmetry of the tool 7 in relation to the predetermined axis of symmetry 8, the target pose 16 of the tool will be effectively, i.e. functionally, reached or set independently of the tool 7 rotation 20 or angular setting in relation to the axis of symmetry 8. The method may be applied in a similar way for tools or other objects, that also do not have to be rotationally symmetrical. It may be sufficient for a respective axis to be predetermined or defined. Rotation about the predetermined axis will then be deemed or treated as irrelevant or insignificant or random, i.e. freely selectable or settable. The object is thus achieved of positioning the tool 7 effectively in the predetermined target pose 16. Since the virtual rotation 20 is not carried for real on the tool, the marker 9 will also not be rotated as well. This provides the marker 9 to remain with a higher probability in a field of vision of a corresponding detection device, i.e. to be tracked more reliably. Likewise, the tool 7 may be held for example rotatable about the predetermined axis 8 by the robot 1, for example, on the robot flange 5 or on the tool holder 6. The tool may then be moved manually for example by a user or operator after the positioning of the tool 7 in the predetermined target pose 16 into a desired rotational or rotational position. The method may be employed, if for the respective user or operator a rotation or rotational position of the tool 7 about a specific axis is not significant, i.e. freely selectable or random and thus is not subject to any restrictions.

Provided the tool 7 may be positioned by the robot 1 in the predetermined target pose 16 at all in any manner, a real implementable or executable solution for a corresponding control of the robot 1 is thus found. The last element qᵥ* of the path defined compensates where necessary for rotations about the z-axis zᵣ physically not able to be carried out by the real robot 1, so that the path planning module may determine the portion q* corresponding to the real robot 1 with greater flexibility and reliability, so that the real robot 1 has to carry out rotations about the z-axis zᵣ actually able to be carried out physically, in order to position the tool 7 in the predetermined target pose 16 free from collisions and conflicts.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for controlling a robot for automatic positioning of a tool in a target pose, the robot including a movable robot arm that includes a robot flange on an end side, on which the tool is held, the method comprising:
specifying three dimensional space coordinates of a reference point of the tool, of an axis of the tool, and of an orientation of the axis as part of the target pose for the tool;
determining a six dimensional pose of the robot flange corresponding to the target pose of the tool;
augmenting a predetermined kinematics of the robot with a virtual joint arranged in the tool that provides a virtual restriction-free rotation about the predetermined axis of the tool;
providing the six dimensional pose of the robot flange and the expanded kinematics to an automatic path planning module; and
determining, by the automatic path planning module, a path in accordance with which the six dimensional pose of the robot flange may be moved to from the current initial pose of the robot; wherein any conflicts occurring during the move with a maximum physical scope of movement of the robot are resolved automatically by a rotation of the virtual joint.

2. The method of claim 1, further comprising:
transferring the path determined automatically to a control device of the robot; and
activating the robot automatically the control device in accordance with the path determined, so that the robot flange arrives at the pose determined and the tool arrives at the predetermined target pose.

3. The method of claim 1, wherein that current values of joint variables of real joints of the robot in the initial pose are determined automatically, a first set of joint variables is provided as part of the expanded kinematics, and a second set of joint variables is determined by the automatic path planning module as part of the path, wherein the first set refers to the virtual joint and the second set to target values of the respective joint variables corresponding to the predetermined target pose.

4. The method of claim 1, wherein determining the path further comprises using a center point of the tool as the position of the virtual joint.

5. The method of claim 1, wherein a tip of the tool facing away from the robot flange is used as the reference point of the tool.

6. The method of claim 1, wherein determining the path further comprises using a virtual connecting element that connects the virtual joint to the reference point or to a tip of the tool facing away from the robot flange.

7. The method of claim 1, wherein the reference point of the tool is the position of the virtual joint.

8. The method of claim 1, further comprising:
transferring an ancillary condition is transferred to the automatic path planning module that is complied with automatically by the automatic path planning module when the path is determined by at least one virtual rotation of the virtual joint provided no conflict with a physical limitation of the robot occurs.

9. The method of claim 8, wherein the ancillary condition is a property of a pose of the robot arm when the tool reaches the target pose.

10. A non-transitory computer implemented storage medium that stores machine-readable instructions executable by at least one processor to control a robot for automatic positioning of a tool in a target pose, the robot including a movable robot arm that includes a robot flange on an end side, on which the tool is held, the machine-readable instructions comprising:
specifying three dimensional space coordinates of a reference point of the tool, of an axis of the tool, and of an orientation of the axis as part of the target pose for the tool;
determining a six dimensional pose of a robot flange corresponding to the target pose of the tool;
augmenting a predetermined kinematics of the robot with a virtual joint arranged in the tool that provides a virtual restriction-free rotation about the predetermined axis of the tool; and
determining a path in accordance with which the six dimensional pose of the robot flange may be moved to from the current initial pose of the robot; wherein any conflicts occurring during the move with a maximum physical scope of movement of the robot are resolved automatically by a rotation of the virtual joint.

11. A robot comprising:
a movable robot arm comprising a robot flange for holding a tool on an end side; and
a control device comprising an interface for receiving specifications, a data memory and a processor device connected to the data memory and to the interface for executing the program code stored in the data memory comprising instructions to:
specify three dimensional space coordinates of a reference point of the tool, of an axis of the tool, and of an orientation of the axis as part of the target pose for the tool;
determine a six dimensional pose of a robot flange corresponding to the target pose of the tool;
augment a predetermined kinematics of the robot with a virtual joint arranged in the tool that provides a virtual restriction-free rotation about the predetermined axis of the tool; and
determine a path in accordance with which the six dimensional pose of the robot flange may be moved to from the current initial pose of the robot; wherein any conflicts occurring during the move with a maximum physical scope of movement of the robot are resolved automatically by a rotation of the virtual joint.
